(19) United States
(12) Patent Application Publication
(10) Pub. No.: US 2015/0295984 A1
(43) Pub. Date: Oct. 15, 2015

(54) Multi Web Application Management Framework System and Method

(71) Applicant: Daniel Tan, Humble, TX (US)

(72) Inventor: Daniel Tan, Humble, TX (US)

(73) Assignee: PetroGrid LLC, Humble, TX (US)

(21) Appl. No.: 14/251,669

(22) Filed: Apr. 14, 2014

(51) Int. Cl. H04L 29/08; H04L 29/06

(52) U.S. Cl. CPC H04L 67/02; H04L 67/42

(57) ABSTRACT

A multi-web application management framework system and method is disclosed. A method for managing multiple web applications using a client-side application management framework system can comprise the steps wrapping an application in an isolation container using an isolation service stored in a memory, and storing the application in the isolation container in the memory. A client computer within a system for managing multiple web application can comprise a processor and a memory. The processor can, at the direction of an isolation service, wrap an application in an isolation container. The memory can store a client-side application management framework. The client-side application management framework can comprise the isolation container, and the isolation container can comprise the application. The memory can also comprise a client-side application service. The client-side application service can be an isolation service.

### BACKGROUND

This disclosure relates to a multi-web application management framework system and method. For purposes of this disclosure, various configurations are discussed, and are an example of a multi-web application management framework system and method. However, such discussion is solely exemplary, and not limiting.

For many years now, websites and web applications have operated under a steady paradigm. First, a web browser can request a particular webpage. Then a web server could map the http address to specific files and functions in an application server. Next, an application server could take data from a database and populate html code with that data. Further, if the page contained interactive elements such as buttons, the application server could define operative functionality of the interactive elements. Finally, the completed webpage could be sent back to the client. Within this paradigm, the assumption has always been that there is a single application per client.

In 2013, United States patent application entitled “Interactive Web Application Framework” (patent application Ser. No. 13/250,537, hereinafter referred to as “Application '537”) was published by the US Patent & Trademark Office. Such application contains an example of this old paradigm. In Application '537, FIG. 1 discloses a web application framework. As disclosed, a browser can communicate with a web server over a network. The web server comprises an HTTP request handler that handles HTTP requests. The web server is in communication with an application server. The application server can comprise a user interface manager as well as some logic. The application server is in communication with a database server. The database server can comprise a database containing data used to populate the webpages.

In Application '537, FIG. 2A discloses another paradigm and a conventional system for a notification-based, database backed web application. As disclosed in FIG. 2A, a web 2.0 client can communicate over a network with a web server. The web server can comprise an HTTP request handler and an Instant Web Publishing (IWP) Interface. The IWP Interface can communicate with an IWP Engine comprising a web-side application server and a Database side Application server connected by an asynchronous communication layer. FIG. 2B further discloses that the web-side app server can comprise an interactive app module to directly communicate with the IWP interface and a web-publishing engine. In such configuration, the client can request for a website to edit. The web server can process the client request. Then the web server can pass the request to the IWP, and the IWP can fetch the requested website from the database. Next, web server can then send the requested website back to the client. If a second client requests the same website to view or edit, the same process occurs, and the same client is now viewing or editing the same data. In Application '537, when either of those two clients makes an edit to the code, the IWP engine sends the change to the database and notifies all other clients of that change. At that time, the other clients can now resolve the discrepancy between their data and their updated data in the database.

The primary advantage of the prior art described above is that it allows for collaborative website development in a manner that synchronizes the development environment of multiple clients. However, this new paradigm does not address the functional limitation and assumption of the previous paradigm. Specifically, web clients are still designed to only run a single application.

As such it would be useful to have a multi-web application management framework system and method.

### SUMMARY

A multi-web application management framework system and method is herein disclosed. A method for managing multiple web applications using a client-side application management framework system can comprise the steps wrapping an application in an isolation container using an isolation service stored in a memory, and storing the application in the isolation container in the memory.

A client computer within a system for managing multiple web application can comprise a processor and a memory. The processor can, at the direction of an isolation service, wrap an application in an isolation container. The memory can store a client-side application management framework. The client-side application management framework can comprise the isolation container, and the isolation container can comprise the application. The memory can also comprise a client-side application service. The client-side application service can be an isolation service.

Lastly, disclosure teaches a non-transitory computer readable storage medium having a computer readable program code embodied therein. The computer readable program code can be adapted to be executed to implement the above mentioned method.

### BRIEF DESCRIPTION OF THE DRAWINGS

FIG. 1 illustrates a multi-web application management framework system.

FIG. 2 illustrates a client comprising a client-side application management framework.

FIG. 3 illustrates a web application server.

FIG. 4 illustrates a database server comprising data.

FIG. 5 illustrates a preferred method for managing multiple web applications.

FIG. 6 illustrates a multi-web application management framework system comprising multiple clients.

FIG. 7 illustrates a preferred method for managing multiple web applications with a multi-web application management framework system comprising multiple clients.

FIG. 8A illustrates an exemplary method for isolating an application in a multiple web application management framework system.

FIG. 8B illustrates wrapping an application in an isolation container.

FIG. 9 illustrates an exemplary method for interoperability of multiple web application management framework system across multiple isolated applications.

FIG. 10 illustrates an exemplary method for persisting a session of a complex application composed of multiple isolated applications.

FIG. 11 illustrates an exemplary method for content data to be updated asynchronously by web application server upon content data changes in database.

FIG. 12 illustrates a schematic block diagram of a computing resource according to an embodiment of the present disclosure.

### DETAILED DESCRIPTION

Described herein is a multi-web application management framework system and method.

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

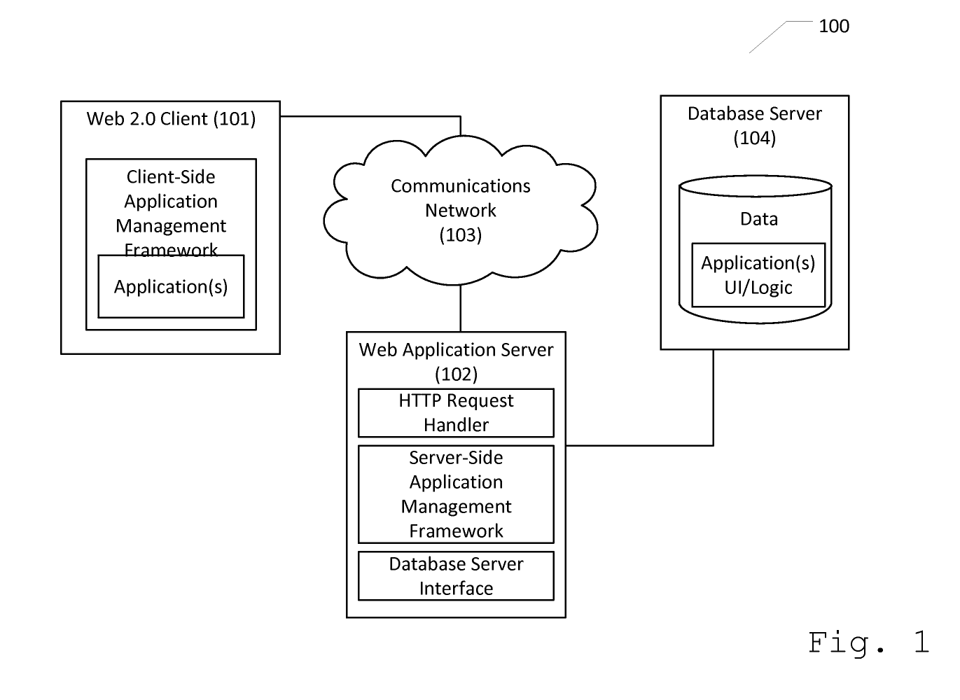

FIG. 1 illustrates a multi-web application management framework system 100. Multi-web application management framework system can comprise a client 101 connectable to a web application server 102 over a network 103, and a database server 104. Client 101 can be capable of downloading files for manipulation, running applications, and requesting application-based services from web application server 102. Web application server 102 can any computer comprising software enabling it to serve up a client application management framework to client 101 and perform business logic. Database server 104 can connect to web application server 102 locally or over network 103. Network 103 can be a wide area network (WAN), or a combination of local area network (LAN), and/or piconets. Network 108 can be hard-wired, wireless, or a combination of both. A LAN can be a network within a single organization while WAN can be the Internet or intranet.

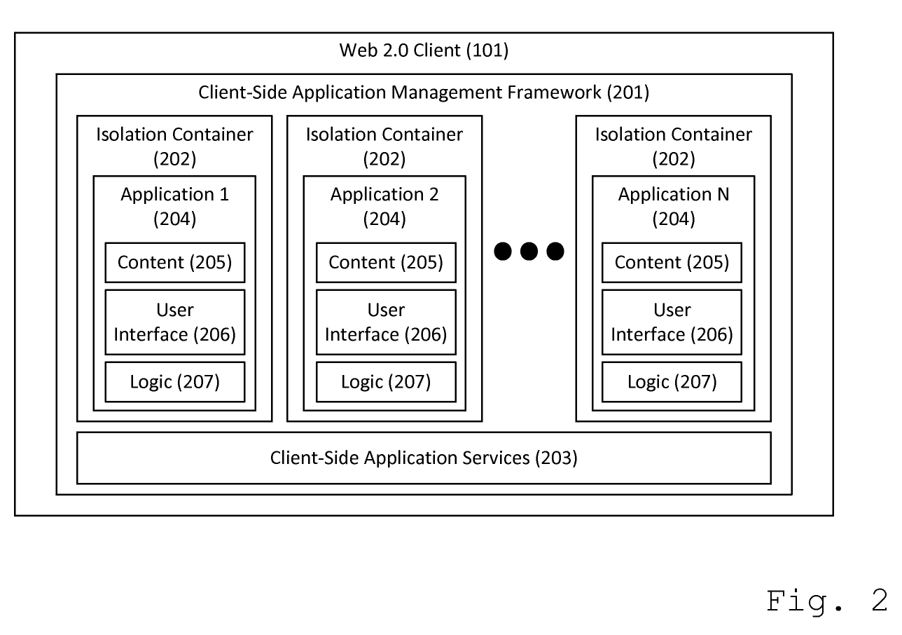

FIG. 2 illustrates client 101 comprising a client-side application management framework 201. Client-side application management framework 201 can comprise one or more isolation containers 202 and client-side application services 203. Each isolation container 202 can comprise or consist of a web application 204. Isolation container 202 isolate web application 204 from every other web application fetched by client 101. Each web application 204 can comprise content 205, a user interface 206 and logic 207.

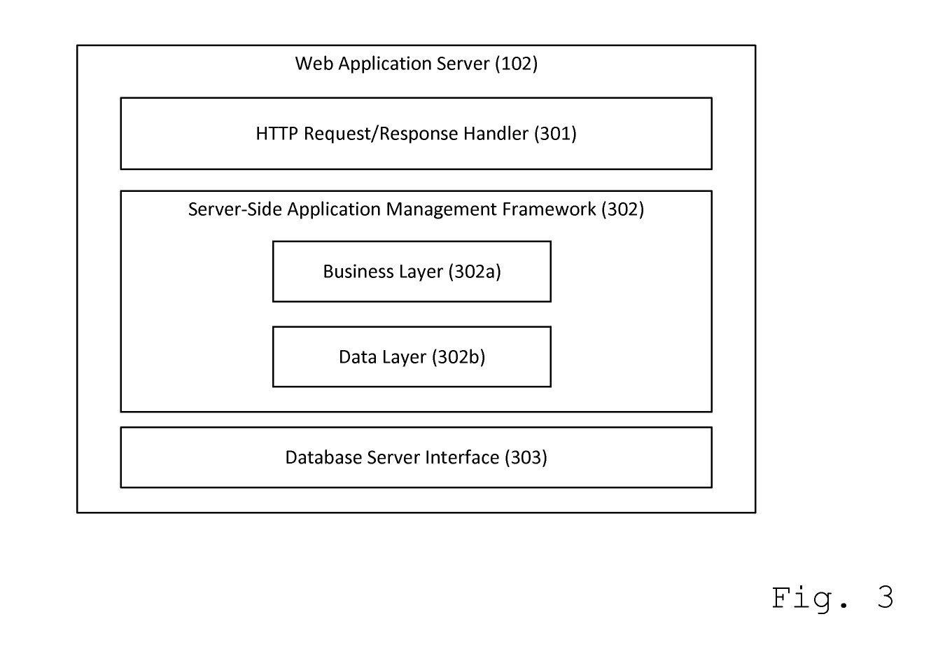

FIG. 3 illustrates a web application server 102. Web application server 102 can comprise a hypertext transfer protocol (HTTP) request/response handler 301, a server-side application management framework 302, and a database server interface 303. HTTP request/response handler 301 can represent a routine for processing specific group of HTTP requests. As such, HTTP request/response handler 301 can generate a response object with content as a response to the given request from web client 101. Server-side application management framework 302 can comprise a business layer 302a and a data layer 302b. Business layer 302a can be the part of server-side application management framework 302 that implements business logic and define business entities. Data layer 302b can provide logic to map a generic request for data into a specific routine to access, modify, or delete data from a specific type of persistent data storage. Database server interface 303 can comprise software, utilities, and APIs that enable the native server code to perform routines in the database language.

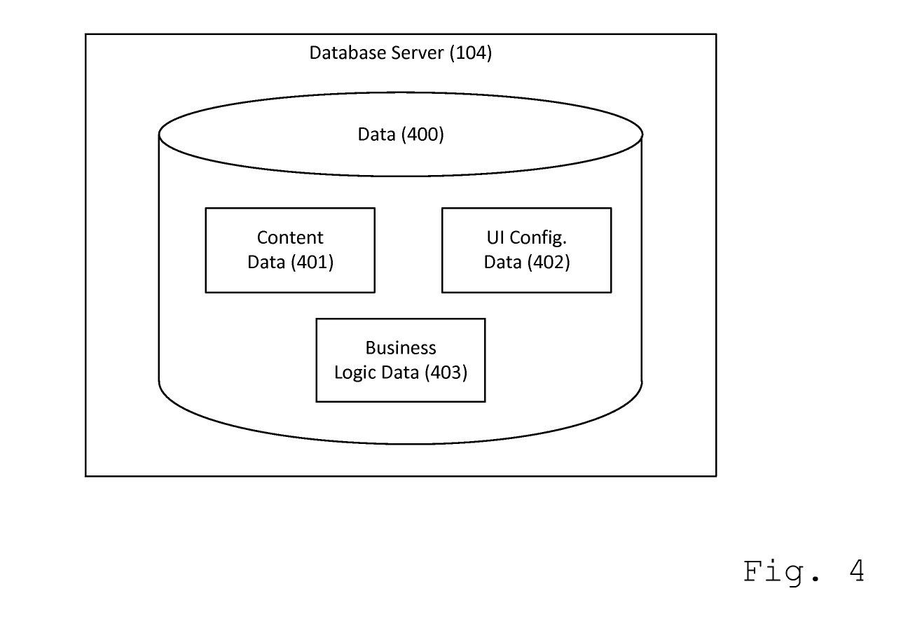

FIG. 4 illustrates a database server 104 comprising data 400. Data 400 can comprise content data 401, a user interface (UI) configuration data 402, and business logic data 403. UI configuration data 402 can comprise one or more sets of UI data, each associated with a specific application intended to be run within web client 101. Similarly, business logic data 403 can comprise one or more sets of business logic data, correlating with a set of UI configuration data 402, and associated with the same specific application.

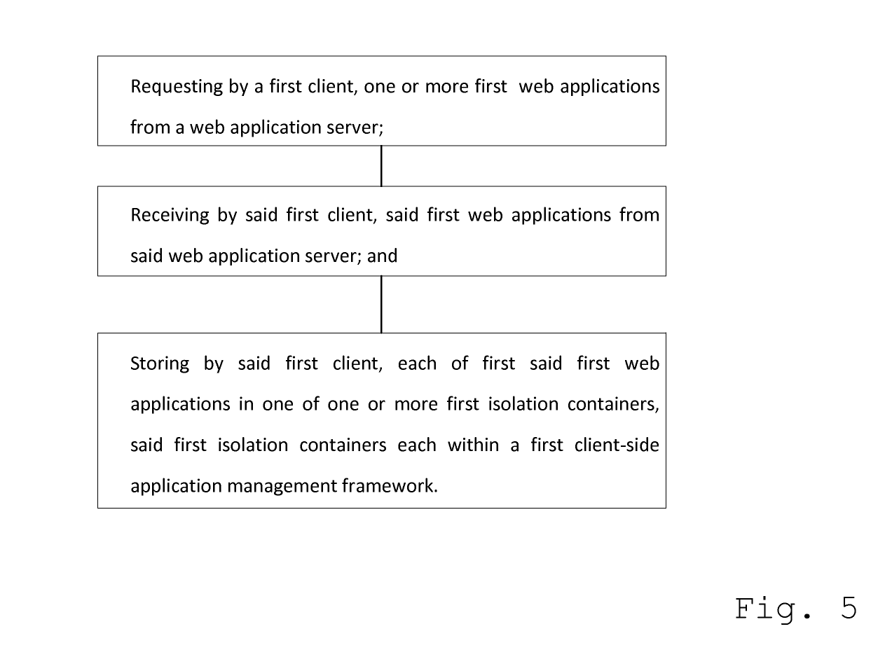

FIG. 5 illustrates a preferred method for managing multiple web applications. In the method, client 101 can send a request to web application server 102 for a web application 204 stored in database server 104. Using database server interface, web application server 102 can retrieve requested web application 204. In one embodiment, web application server 102 can form web application 204 at least in part using UI configuration data 402 and business logic data 403. Web application 204 can then interrogate data 400 to request content data 401 as necessary. Next, server-side application management framework 201 and/or client-side management framework 302 can wrap the web application 204 in isolation container 202. Isolation container 202 allows client 101 to fetch and run multiple web applications 204 within client 101 without web applications 204 colliding with one another.

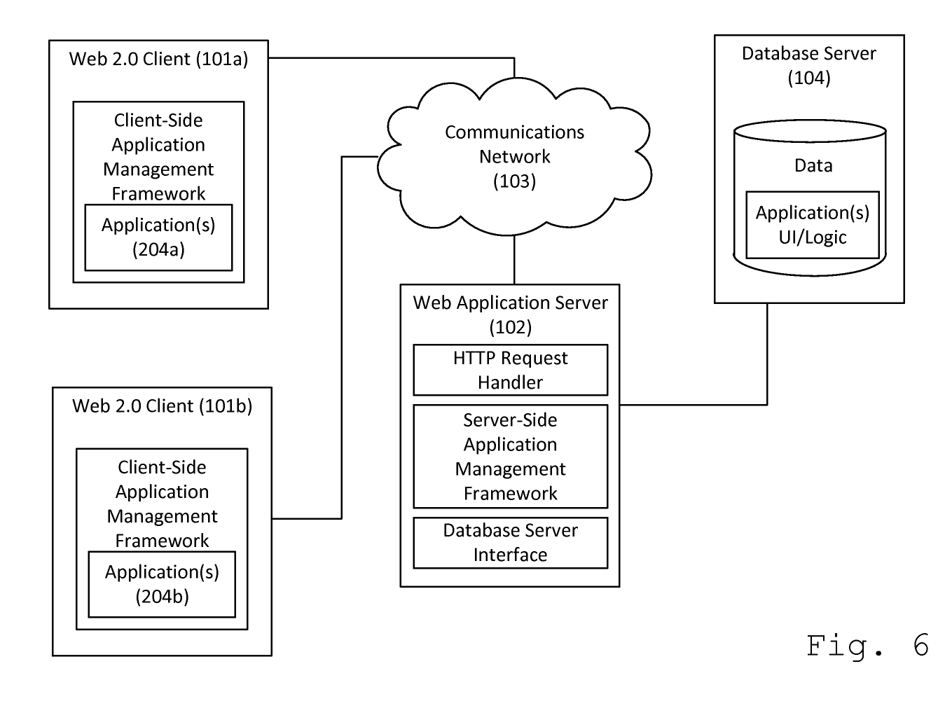

FIG. 6 illustrates a multi-web application management framework system 100 comprising multiple clients 101. In such an environment, each client 101 can comprise a client-side application management framework as described in the discussion of FIG. 2. Similar to the configuration in FIG. 1, both clients 101 can communicate with web application server 102 over network 103.

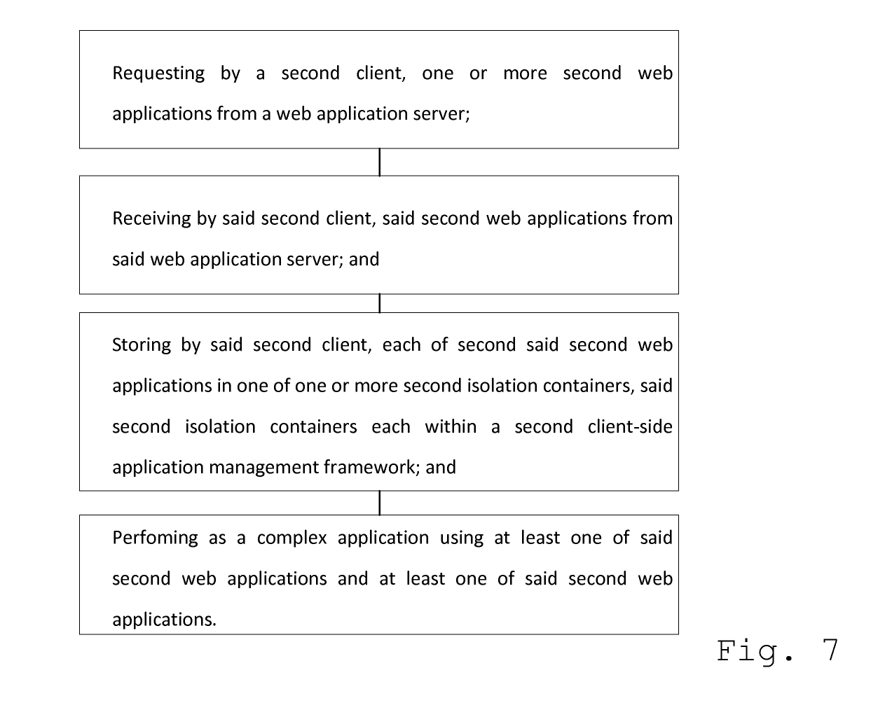

FIG. 7 illustrates a preferred method for managing multiple web applications with a multi-web application management framework system 100 comprising multiple clients 101. Similar to the method illustrated in FIG. 5, clients 101 can each send requests to web application server 102 for web applications 204 stored in database server 104. After retrieval, web application server 102 can transmit the web application 204 to appropriate client 101.

Since the framework exists on client and the server environment, first web application 204a within client 101a can be enabled to have explicit and controlled communication with web application 204b in client 101b. Web application server 102 can observe controlled communication among applications. One or more of clients 101 can track controlled communication between applications across clients 101 through web application server 102. This enables the replication of any permutation of web application connections and/or web client connections. One advantage of the disclosed system and method is the ability to build complex applications distributed across a network that are composed of several web applications 204, all of which can be developed without much explicit knowledge concerning the existence of each web application 204. Each web application 204 is an application in its own right, but can become a component of a larger application. These complex applications can be on one or more clients 101.

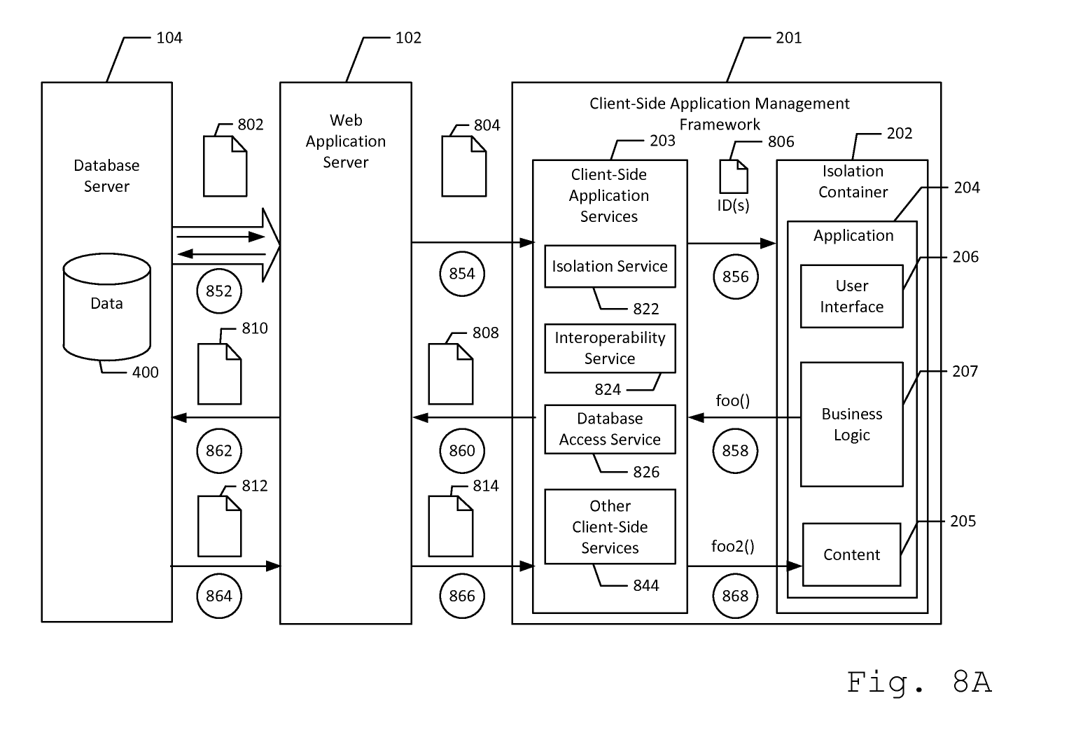

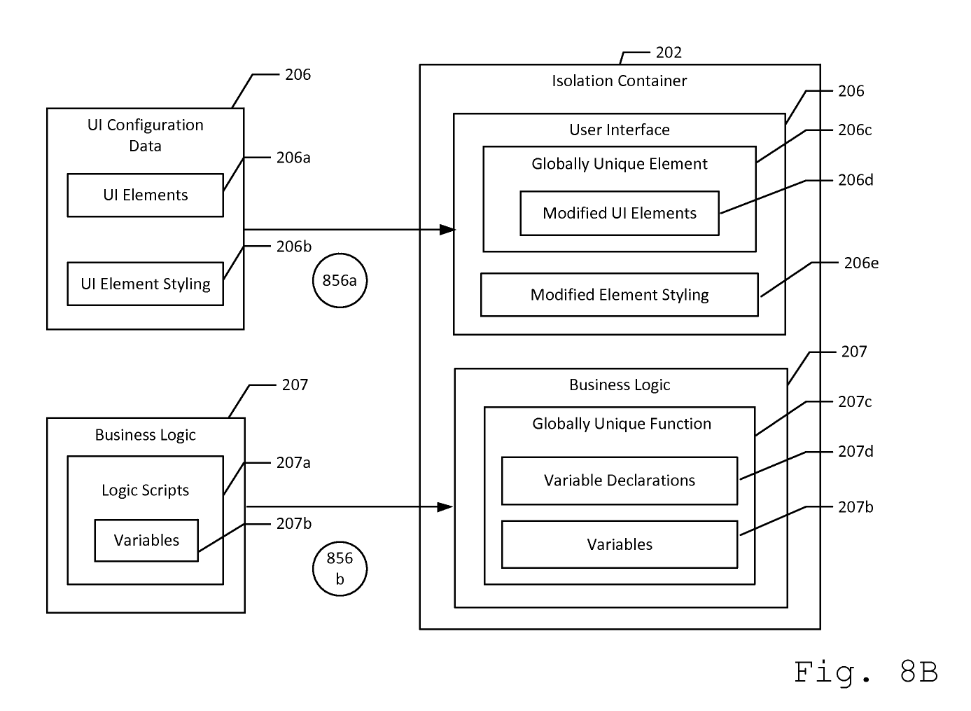

FIG. 8A illustrates an exemplary method for application isolation processing in a multiple web application management framework system 100. A functional limitation of the web paradigm of the prior art is the assumption of a single application environment. Websites and web applications have a single Document Object Model (DOM) with a single body and thus a logically single environment in memory where UI elements and business logic exist and are executed. Thus, for example, within that single context of the prior art, multiple UI elements that are defined with the same identifiers cannot coexist without potential conflict, multiple styling rules that target UI elements with the same identifiers cannot coexist without potential conflict, and multiple scripts that use the same names cannot coexist without potential conflict. By comparison client-side application management framework 201 performs an isolation processing to effectively render a single application environment to be a multiple web application environment. Isolation processing can enable multiple applications or sets of UI configuration data and business logic data to coexist and be executed within the same DOM and not have application code conflicts. In a multiple web application management framework system 100, application isolation processing and an isolated application's access to content data can, in one embodiment, comprise the following stages. First, FIG. 8A illustrates how raw application code is isolated and delivered from the database 400 to the client-side application management framework 201 for execution. Second, FIG. 8A illustrates how an isolated application 204 is able to request content data from database 400. Third, FIG. 8A illustrates how database 400 can deliver requested content data back to isolated application 204.

Isolating and delivering raw application code can, in one embodiment, comprise three sub-processes, processes 852, 854, and 856. Process 852, can be performed by database server 104 as follows: when database server 104 receives a request for a specific application 204 from a client through web application server, database server 102 can respond delivering from database 400 raw code 802 of requested application 204 to web application server 102. Raw code 802 can comprise UI configuration data 206 and business logic data 207. Web application server can perform process 854. Having received raw application code 802, web application server 102 can perform any preprocessing necessary to prepare raw application code 802 to be isolated by client-side application management framework 201. Preprocessing can comprise, but is not limited to, parsing and evaluating raw code 802, to help ensure client-side application management framework 201 receives a safe-to-run application 204. In one embodiment, code preprocessing can evaluate useful metadata about the application code (e.g. application name, version, size, etc.) that can be useful to the client-side application management framework 201 isolation processing. A message 804 can be sent from web application server 102 to client-side application management framework 201. Message 804 can comprise the unprocessed or pre-processed application code 802. Once received, an isolation service 822 within client-side application management framework 201 can perform process 856 as follows: Client-side application management framework 201 can process message 804 by wrapping UI configuration data 206 and business logic data 207 in isolation container 202. Isolation container 202 can be a set of operations needed to ensure that the runtime execution of the requested application 204 is isolated.

FIG. 8B further illustrates process 856. All forms of potential application code conflict can be addressed by client-side application management framework 201. UI configuration data can be isolated (process 856a). For example, process 856a can comprise wrapping all UI elements 206a defined by the UI configuration data 206 in a globally unique UI element 206c, parsing the UI elements 206a and replacing any identifiers used by the UI elements 206a with globally unique identifiers resulting in modified UI elements 206d, parsing the UI elements 206a and replacing any references to business logic 207 made by the UI elements 206a with globally unique references, parsing the UI element styling rules 206b and replacing any identifiers referenced by the UI element styling rules 206b with globally unique identifiers resulting in modified element styling rules 206e that correlate with the identifiers used by the modified UI elements 206d.

Additionally business logic data can be isolated (process 856b). Process 856b can comprise wrapping business logic scripts 207a in a globally unique function 207c to restrict the scope of business logic variables 207b to an isolated scope, parsing the business logic scripts 207a and adding variable declarations 207d within the globally unique function 207c to limit the scope of those variables to only the scope of the globally unique function 207c, and parsing the business logic scripts 207a and replacing any references to UI elements 206a made by the business logic scripts 207a with globally unique references. After these operations are executed, all the application code should be globally unique and thus not collide with code from any other application. Some or all of these operations, though they are executed prior to the application's runtime, can and may need to be performed repeatedly throughout the life of the application code's execution to ensure that any dynamic changes to the application code during the application's runtime do not render the application no longer isolated. It should be noted that as is true even of application code executed in the systems of the prior art, within multiple web application management framework system 100, application code can still be expected to adhere to a certain set of basic rules and assumptions outside of which isolated application execution may experience unexpected behavior, the handling of which may be undefined. Isolation processing operations can be defined in a message 806 that uniquely identifies requested application 204 and contains the instructions needed to execute application 204 within client-side application management framework 201. Thus, application 204 can be executed and a user can interact and manipulate application 204. At this stage, application 204 can comprise a user interface and business logic, however application 204 does not yet contain any content data 205 from database 400.

Accessing content from database 400 can, in one embodiment, comprise three sub-processes, process 858, 860, and 862. Client-side application management framework 201 can perform process 858 as follows. First, application 204 can request content data 205 from database 400. Client-side application services 203 can provide an interface common to all isolated applications 204 to access data from database 400. Business logic 207 can perform an operation foo( ) that requests content data 205 from database access service 826. Such request from business logic 207 can also include a provision for explicit access by database access service 826 to run a function on application 204 when content data 205 is delivered back to application 204's request. Every request of any application 204 for content data 205 by business logic 207 can be monitored by data access service 826, in one embodiment. In another embodiment, content data 205 can also be monitored by other relevant client-side services 844 such as an interoperability service 824.

Furthermore, client-side application management framework 201 can also perform process 860 as follows. Once request for content data 205 from application 204 is received, database access service can translate the request into a request message 808, which web application server 102 can interpret. Moreover, process 862 can be performed once the request for content data 205 from client-side application services 203 is received. Web application server 102 can translate request message 808 into specific database operations 810 that database server 104 can execute.

In one embodiment, delivering content to isolated application from database can comprise three sub-processes 864, 866, and 868. Upon receiving instructions from web application server 102, process 864 can be performed by database server 104 by delivering raw content data 812 to web application server 102. Web application server can also perform process 866. Having received raw content data 812 from database server 102, web application server can then perform any preprocessing on raw content data 812 to prepare the data for access by client-side application management framework 201 and client-side application services 203. This unprocessed or pre-processed data 814 can then be delivered to client-side application services 203. Additionally, client-side application services 203 can perform process 868. Having received content data message 814 from web application server 102, client-side application services 203, including database access service, can then deliver content data 205 to application 204 that requested content data 205 and run business logic function, foo2( ) that application 204 may have exposed to client-side application services 203 in process 858. At this stage, isolated application 204 can now have content data 205 and can have executed any related functions tied to the receiving of content data 205.

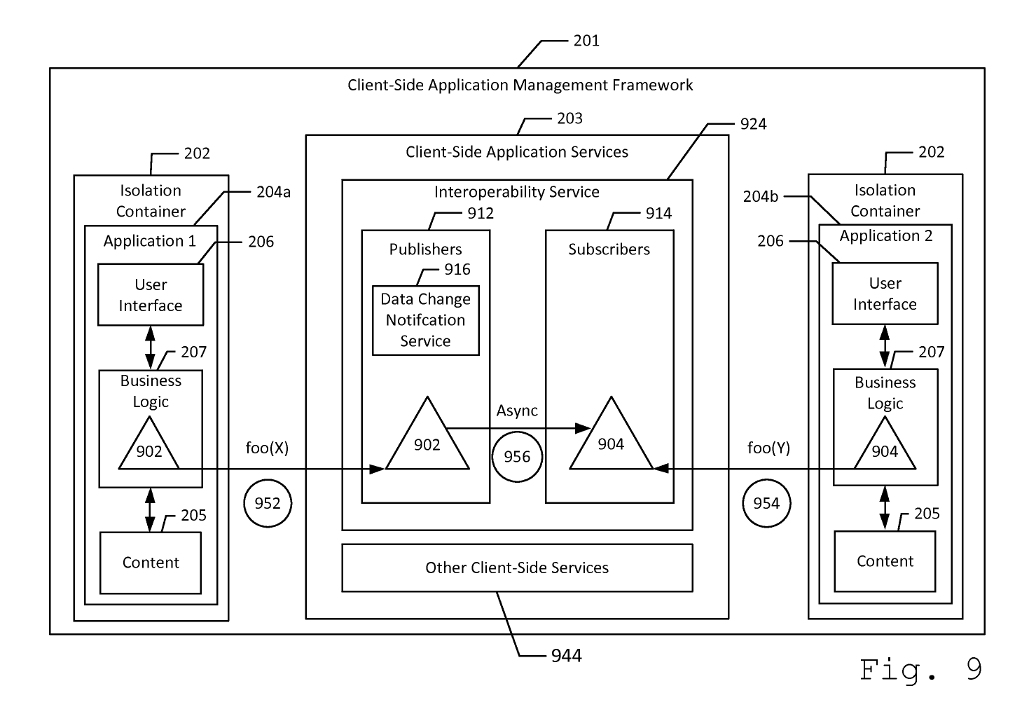

FIG. 9 illustrates an exemplary method for interoperability across multiple isolated applications 204 in a multiple web application management framework system 100. Every isolated application 204 can function as a component of a larger application, either within a single client or across multiple clients. Since applications 204 are by default isolated from one another in a single client environment, client-side application management framework 201 can allow client-side application services 203 to enable explicitly defined interactions between multiple isolated applications 204. First FIG. 9 illustrates how a first component 902 of business logic 207 can be exposed by first isolated application 204a. Second, FIG. 9 illustrates how a second component 904 of business logic 207 can be exposed by a second isolated application 204b. And lastly, FIG. 9 illustrates how the two sets of exposed components of business logic can be synchronized by interoperability service 824.

Exposing first component 902 of business logic 207 by first isolated application 204a can comprise a sub-process, process 952. Process 952 can execute as follows: all isolated applications 204 can have a common interface to access interoperability service 824. Through this interface, first isolated application 204a, can expose a specific first component 902, of first isolated application 204a business logic. Exposed first component 902 can include a function, foo( ) that represent instructions needed by second application 204b to manipulate first component 902. These instructions can include the modification of application's UI 206 and/or content data 205. The exposed component from first isolated application 204a can be made visible to second isolated application 204b via interoperability service 824.

Furthermore exposing second component 904 of business logic 207 by second isolated application 204b can comprise a sub-process, process 954. Process 954 can execute as follows: to gain access to first component 902 and any associated instructions exposed by first isolated application 204a, second isolated application 204b must also expose second component 904 of second isolated application 204b business logic 207 along with any necessary associated instructions, foo( ). Having both first component 902 and second component 904 exposed to interoperability service 824, interoperability service 824 can then be able to synchronize these components.

Additionally, synchronizing two sets of exposed component of business logic 207 via interoperability service 824 can comprise a sub-process, process 956. Process 956 can execute as follows: once more than one application 204 has exposed a component of its business logic 207, interoperability service 824 can set one of the components, e.g. first component 902, as a publisher 912 and the other component, e.g. second component 904, as a subscriber 914. A data change notification service 916 can observe all changes made to any publisher 912. Whenever first component 902 experiences a change, data change notification service 916 can trigger functions that can propagate the change of first component 902 to subscriber second component 904 and run any associated instructions provided by the exposure of second component 904 during sub-process 954. The role of publisher and subscriber can be interchangeable: second component 904 can serve as publisher 912 and first component 902 can serve as subscriber 914. Moreover, every isolated application 204 can expose more than a single component of its business logic 207. Therefore there can be more than one publisher 912 exposing one or more components 902 each associated with one or more subscribers 914 all being managed by client-side application management framework's 201 interoperability service 824.

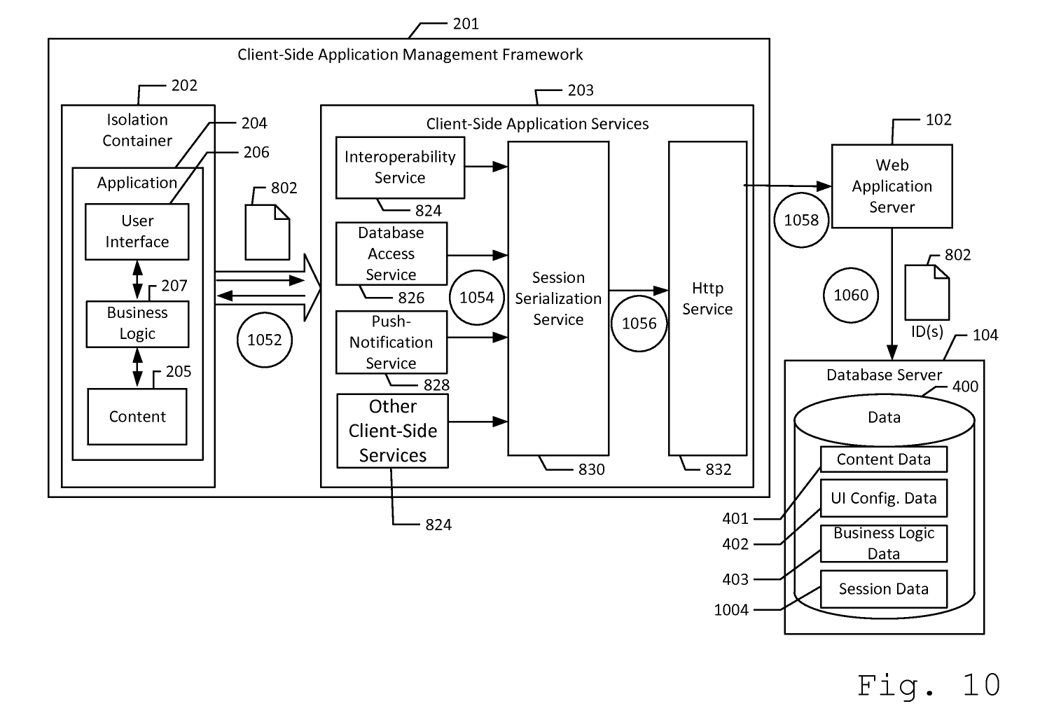

FIG. 10 illustrates an exemplary method for persisting a session of a complex application composed of multiple isolated applications 204. Since each isolated application 204 can function as a component of a larger application (either all in a single client or traversing multiple clients), it can be desirable to have the state of the larger application persist beyond the current client(s) session(s). This can require aspects of the larger applications state. Thus, the aspects of all the associated isolated application 204 states can be compiled as session data 1004, which can then be persisted to database 400. This process can comprise three main stages. First, the state of one or more isolated applications 204 can be submitted to client-side application services 203. Second, the state of all client-side application services 203 can be submitted to web application server 102. Third, web application server 102 can submit a compiled session data 1004 to data server 104 for saving.

Submitting the state of isolated applications 204 to client-side application services 203 can comprise a sub-process, process 1052. Process 1052 can execute as follows: through a common interface provided by client-side application services 203 to isolated applications 204, one or more isolated applications 204 can deliver through one or more messages 902, the state of isolated applications 204 user interface configuration data 206, business logic data 207, and/or content data 205 to the client-side application management framework's 201 session serialization service 830.

Furthermore, submitting the state of client-side application services 203 to web application server 102 can comprise sub-processes, process 1054, 1056, and 1058. Process 1054 can execute as follows: all relevant client-side application services 824, 826, 828, and/or 844 that have states associated with the current session deliver their respective states to session serialization service 830. Thus, for example, any interactions between isolated applications 204 defined by interoperability service 824 can be persisted along with the state data of individual applications 204 themselves. Any transactions isolated applications 204 made with the database known by database access service 826 can also be persisted. Thus, any and all state data for all relevant client-side application services 824, 826, 828, and/or 844 can be delivered to session serialization service 830 for compiling. Once all individual application states 802 and the associated states of the relevant client-side application services 824, 826, 828, and/or 844 are delivered to session serialization service, process 1056 can execute when the session serialization service delivers a compiled session data to HTTP service 832. Once HTTP service 832 receives the compiled session data, process 1058 can execute as HTTP service 832 delivers the data to web application server 102. Depending upon the size of the compiled data, HTTP service 832 can send the data to the server over multiple transactions.

Moreover, submitting a compiled session data 1004 to data server 104 by web application server 102 can comprise a sub-process, process 1060. Once web application server 102 receives entirety of the compiled session data from client-side application management framework 201, process 1060 can execute as web application server 102 compiles a final message 1002 containing the session data and any additional data needed to uniquely identify the current session's state data from another session's state data. Web application server 102 can call the appropriate database operations to persist session data 1004 to the database.

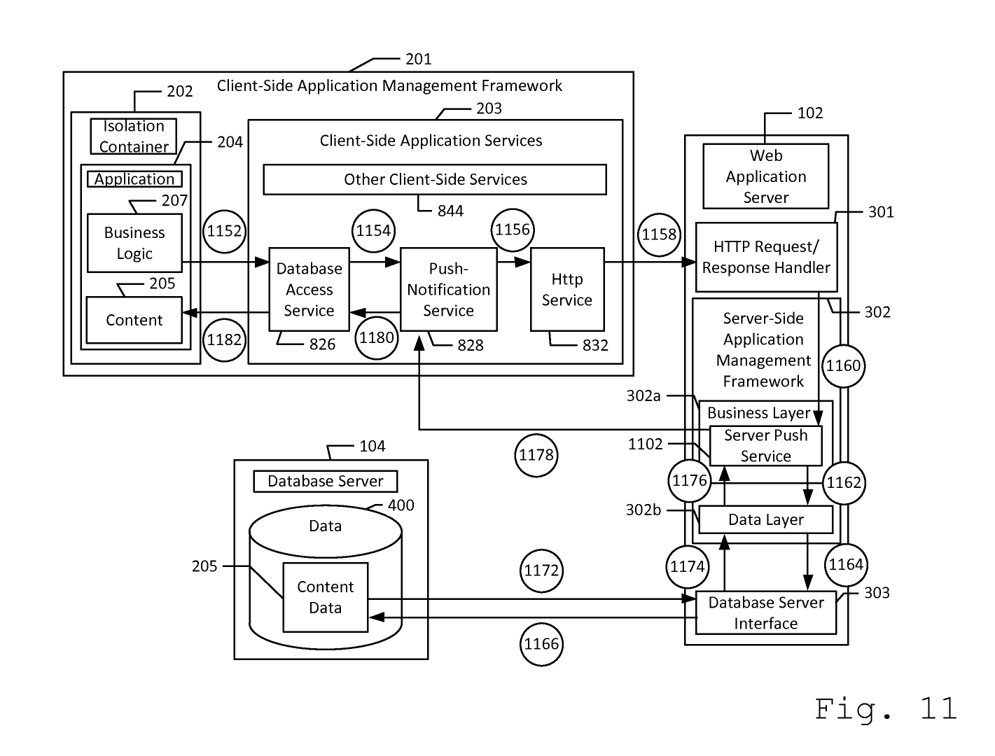

FIG. 11 illustrates an exemplary method for content data 205 to be updated asynchronously by web application server 102 upon content data 205 changes in database 400. It can be desirable for any content data 205 requested by isolation application 204 to be kept up to date based upon the values of the content data stored in database 400. Furthermore, updating can occur asynchronously as data server 104 and web application server 102 initiated process as opposed to occurring as a response to a synchronous client request for the most current content data 205. This enabling of a server push service is accomplished through 2 main stages. First stage is the request of content data 205 from isolated application 204. Second stage is the server-initiated delivery of new content data 205 whenever the requested content data 205 values change in database 400.

Requesting of content data 205 from isolated application 204 can comprise of sub-processes, process 1152, 1154, 1156, 1158, 1160, 1162, 1164, and 1166. Isolated application 204 can perform process 1152 by making a request for specific content data 205 from the database. Such request for specific content data 205 can be made through an interface provided by database access service 826. Furthermore, the request can be associated with instructions provided by isolated application's 204 business logic 207. Process 1154 can execute as follows: any provided instructions by isolated application 204 can be registered in client-side push-notification service 828. Instructions can include what business logic to execute upon an update of the requested content data 205. Further, the registration can open a direct connection to web application server 102, which exposes the provided instructions by isolated application 204 to web application server 102 to enable web application server 102 to directly execute those instructions upon the update of content data 205.

Process 1156 can be as follows: the request for content data 205 from database access service 826 and any necessary data associated with the request from the push-notification service 828 can then be delivered to HTTP service 832. Once the request for content data 205 by an isolated application 204 is received by HTTP service 832, process 1158 can execute by delivering HTTP service 832 to web application server's 102 HTTP request/response handler 301. HTTP request/response handler 301 can translate the client request into a specific server-side application management framework 302 routine. Process 1160 can execute, after HTTP request/response handler 301 through a server push service 1102 delivers the request for content data 205. Here a server-side reference to the instructions registered on client-side push-notification service 828 can be made. This can provide a method for web application server 102 to directly trigger the execution of the instruction registered in client-side push notification service 828. The request for content data 205 can then be delivered to server-side application management framework's 302 data layer 302b. Process 1162 can be performed through translating client request into specific database routines to query content data 205 requested by the client. Furthermore, data layer 302b can register a method in server-side application management framework 302 for database server 104 to execute whenever content data 205 that is associated with the aforementioned request is updated. Process 1164 can then execute as data layer 302b delivers the generated routines to database server interface 1264 to be communicated to the database server. Once the database server interface 303 delivers the routines generated by data layer 302b to database server 104, process 1166 can execute. Database server 104 can then executes those routines and delivers the resulting content data 205 back to isolated application 204.

Delivery of new content data 205 when requested content data 205 changes in database 400 can comprise of sub-processes, process 1172, 1174, 1176, 1178, 1180, and 1182. Process 1172 can execute as follows: whenever content data 205 associated with the original request by isolated application 204 is updated, database server 104 can communicates to web application server 102 through database server interface 303 that content data 205 associated with the registration created prior in process 1162 has changed. Process 1174 performs as database server interface 303 delivers the change notification from database 400 to the registered method in data layer 302b created prior in process 1162. The registered method in data layer 302b can then perform process 1176 by executing the registered method in server-push service 1102 created prior in process 1160. Process 1178 can then execute as follows: the registered method in server-side application management framework's 302 server-push service 1102 can then directly execute the registered method in client-side application management framework's 201 push-notification service 828 through the direct connection created prior in process 1154. Process 1180 can then execute as follows: the registered method in the client-side application management framework's 201 push notification service 828, then accesses any needed information from database access service 826 through which the original request for the associated content data 205 was made in process 1152. Finally process 1182 can be performed as the instructions are stored in the push-notification service 828 along with any needed data from database access service 826 are executed to update the state of content data 205 in isolated application 204.

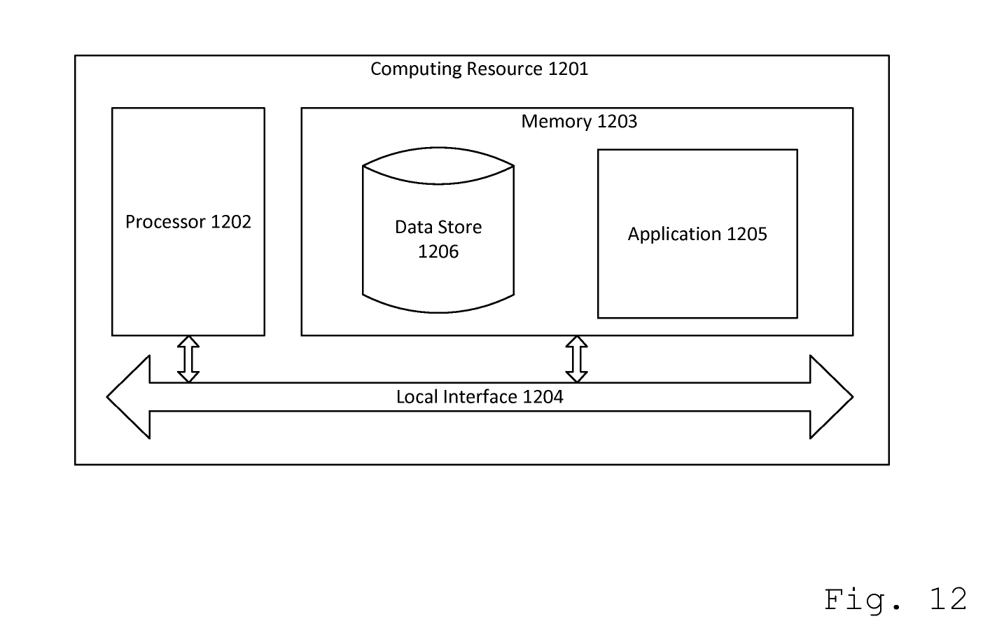

FIG. 12 illustrates a schematic block diagram of a computing resource 1201 according to an embodiment of the present disclosure. An example of computer resource 1201 is client 101 or web application server 102. Each computing resource includes at least one processor circuit, for example, having a processor 1202 and a memory 1203, both of which are coupled to a local interface 1204. Local interface 1204 can comprise, for example, a data bus with an accompanying address/control bus or other bus structure as can be appreciated. Local interface 1204 can include, for example, hardware associated with database server interface 303.

Stored in memory 1203 described herein above are both data and several components that are executable by processor 1202. In particular, stored in the memory 803 and executable by processor 1202 are applications 1205. Applications 1205 can include, but are not limited to, client-side application management framework 201, server-side application management framework 302, and web applications 204. In addition, an operating system can be stored in memory 1203 and executable by processor 1202.

It is understood that there can be other applications that are stored in memory 1203 and are executable by processor 1202 as can be appreciated. Where any component discussed herein is implemented in the form of software, any one of a number of programming languages can be employed such as, for example, C, C++, C#, Objective C, Java, Java Script, Perl, PHP, Visual Basic, Python, Ruby, Delphi, Flash, or other programming languages.

A number of software components can be stored in memory 1203 and can be executable by processor 1202. In this respect, the term “executable” means a program file that is in a form that can ultimately be run by processor 1202. Examples of executable programs can be, for example, a compiled program that can be translated into machine code in a format that can be loaded into a random access portion of memory 1203 and run by processor 1202, source code that can be expressed in proper format such as object code that is capable of being loaded into a random access portion of memory 1203 and executed by processor 1202, or source code that can be interpreted by another executable program to generate instructions in a random access portion of memory 1203 to be executed by processor 1202, etc. An executable program can be stored in any portion or component of memory 1203 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

Also stored in memory 1203 can be a data store 1206. An example of data store 1206 can be database 104. Memory 1203 is defined herein as including both volatile and nonvolatile memory and data storage components. Volatile components are those that do not retain data values upon loss of power. Nonvolatile components are those that retain data upon a loss of power. Thus, memory 1203 can comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM can comprise, for example, static random access memory (SRAM), dynamic random access memory (DRAM), or magnetic random access memory (MRAM) and other such devices. The ROM can comprise, for example, a programmable read-only memory (PROM), an erasable programmable read-only memory (EPROM), an electrically erasable programmable read-only memory (EEPROM), or other like memory device.

Also, processor 1202 can represent multiple processors 1202 and memory 1203 can represent multiple memories that operate in parallel processing circuits, respectively. In such a case, local interface 1204 can be an appropriate network, including network 103 that facilitates communication between any two of the multiple processors 1202, between any processors 1202 and any of the memories 1203, or between any two of the memories 1203, etc. Local interface 1204 can comprise additional systems designed to coordinate this communication, including, for example, performing load balancing. Processor 1202 can be of electrical or of some other available construction.

Although applications 1205, and other various systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowcharts of FIG. 5 and FIG. 7 show the functionality and operation of an implementation of portions of applications 1205. If embodied in software, each block can represent a module, segment, or portion of code that comprises program instructions to implement the specified logical function(s). The program instructions can be embodied in the form of source code that comprises human-readable statements written in a programming language or machine code that comprises numerical instructions recognizable by a suitable execution system such as processor 1202 in a computer system or other system. The machine code can be converted from the source code, etc. If embodied in hardware, each block can represent a circuit or a number of interconnected circuits to implement the specified logical function(s).

Although the flowcharts of FIG. 5 and FIG. 7 show a specific order of execution, it is understood that the order of execution can differ from that which is depicted. For example, the order of execution of two or more blocks can be scrambled relative to the order shown. Also, two or more blocks shown in succession in FIG. 5 and FIG. 7 can be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including applications 1205, that comprises software or code can be embodied in any computer-readable storage medium for use by or in connection with an instruction execution system such as, for example, processor 1202 in a computer system or other system. In this sense, the logic can comprise, for example, statements including instructions and declarations that can be fetched from the computer-readable storage medium and executed by the instruction execution system.

In the context of the present disclosure, a “computer-readable storage medium” can be any non-transient medium that can contain, store, or maintain the logic or application described herein for use by or in connection with the instruction execution system. The computer-readable storage medium can comprise any one of many physical media such as, for example, electronic, magnetic, optical, electromagnetic, infrared, or semiconductor media. More specific examples of a suitable computer-readable storage medium would include, but are not limited to, magnetic tapes, magnetic floppy diskettes, magnetic hard drives, memory cards, solid-state drives, USB flash drives, or optical discs. Also, the computer-readable storage medium can be a random access memory (RAM) including, for example, static random access memory (SRAM) and dynamic random access memory (DRAM), or magnetic random access memory (MRAM). In addition, the computer-readable storage medium can be a read-only memory (ROM), a programmable read-only memory (PROM), an erasable programmable read-only memory (EPROM), an electrically erasable programmable read-only memory (EEPROM), or other type of memory device.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A method for managing multiple web applications using a client-side application management framework system, comprising the steps
wrapping an application in an isolation container using an isolation service stored in a memory; and
storing said application in said isolation container in said memory.

2. The method of claim 1, comprising the preceding steps of
receiving raw code that comprises user interface configuration data and business logic data; and
constructing said application at least in part from said user interface configuration data and said business logic data.

3. The method of claim 1 comprising the additional step of transmitting a request for content from said application within said isolation container, to a client-side application service.

4. The method of claim 3 wherein said client-side application service is an interoperability service.

5. The method of claim 3 wherein said client-side application service is a database access service.

7. The method of claim 5 wherein said application transmits said request for content data by business logic performing an operation foo( ) that requests said content data.

8. The method of claim 3 further comprising the additional steps of
translating said request for content data into a message that a web application server can interpret, and
transmitting said message to said web application server.

9. The method of claim 8 further comprising the additional steps of
receiving by said client-side application services raw content data from said web application server;
translating said raw content data into a processed content data usable by said application within said isolation container; and
transmitting said processed content data from said client-side application services to said application within said isolation container.

10. The method of claim 9 wherein said transmitting said processed content data comprises database access service performing an operation foo2( ) that is defined by said isolated application.

11. A client computer comprising
a processor that, at the direction of an isolation service, wraps an application in an isolation container; and
a memory that stores a client-side application management framework, said client-side application management framework comprising
said isolation container, said isolation container comprising said application, and
a client-side application service, said client-side application service an isolation service.

12. The client computer of claim 11, wherein said application comprises a user interface and business logic.

13. The client computer of claim 12, wherein said isolation service is capable of receiving raw code that comprises said user interface and said business logic, before wrapping said application in said isolation container.

14. The client computer of claim 12 further comprising a second client-side application service that receives a request for content from said application within said isolation container, translates said request for content data into a message that a web application server can interpret, and transmits said message to said web application server.

15. The client computer of claim 14 wherein said second client-side application service is an interoperability service.

16. The client computer of claim 14 wherein said second client-side application service is a database access service.

17. The client computer of claim 14 wherein said second client-side application service further receives by said raw content data from said web application server; translates said raw content data into a processed content data usable by said application within said isolation container; and transmits said processed content data to said application within said isolation container.

18. The client computer of claim 17 wherein said raw content data is received from said web application server unprocessed.

19. The client computer of claim 17 wherein said raw content data is received from said web application server pre-processed.

20. A non-transient computer readable storage medium having a computer readable program code embodied therein, wherein the computer readable program code is adapted to be executed to implement the method of claim 1.
